(19) United States
(12) Patent Application Publication
(10) Pub. No.: US 2005/0270149 A1
(43) Pub. Date: Dec. 8, 2005

(54) Deterrent alarm system

(76) Inventor: Jesse Standing, Calgary (CA)

Correspondence Address: FOLEY & LARDNER, 777 EAST WISCONSIN AVENUE, SUITE 3800, MILWAUKEE, WI, 53202-5308, US

(21) Appl. No.: 10/880,991

(22) Filed: Jun. 30, 2004

(30) Foreign Application Priority Data
Jun. 2, 2004 (CA) 2,470,244

(51) Int. Cl. G08B 29/00

(52) U.S. Cl. 340/506; 340/523

(57) ABSTRACT

A method is provided for controlling a deterrent alarm system for a monitored area comprising the steps of activating an alarm; detecting the presence of a person; and, de-activating the alarm in response to the detected presence of the person. The method may include the additional steps of detecting the absence of the person in the monitored area; and, re-activating the alarm in response to the detected absence. A deterrent alarm system is also provided comprising an alarm; an alarm controller in communication with the alarm for activating and de-activating the alarm; and, a detector in communication with the alarm controller for detecting a person in the monitored area and communicating to the controller one of an indication that the person is detected and an indication that no person is detected, the controller de-activating the alarm in response to the indication that the person is detected and activating the alarm in response to the indication that no person is detected.

### FIELD OF THE INVENTION

The present invention relates to alarm systems in general. In particular, the present invention relates to deterrent alarm systems.

### BACKGROUND OF THE INVENTION

Areas, such as ATM vestibules, lobby entrance ways, stair wells and covered passage ways, may at certain times receive low pedestrian traffic flow. The reasons for this low flow vary. For example, the area itself might be isolated or secluded. Alternately, an area that normally receives moderate to high flow during business hours, receives low traffic flow outside of business hours, during the evening and early morning in particular. As a result, a person is less likely to feel safe in any of these areas during low traffic times, and as such is less likely to visit these areas during these times, thereby resulting in further reduced traffic flow.

For an example of the potential consequences of further reduced traffic flow, consider an ATM vestibule. For many, ATMs have become the exclusive medium through which they conduct bank business. The 24-hour per day availability and widespread presence of ATMs are two advantages over traditional teller banking. ATM banking does have its perils. A late night ATM user's only form of security may be a surveillance camera and a card-activated door, which often times does not work. Robberies do occur. Also, homeless people may use the vestibules as temporary shelters. As a result, the ATM vestibule appears less secure to a potential ATM user. As such, the user is less likely to use the ATM, which inconveniences the user and the results in lost business for the bank or financial institution.

It is an object of the present invention to provide a system to obviate or mitigate at least some of the above-presented problems.

### SUMMARY OF THE INVENTION

The present invention provides a method for controlling a deterrent alarm system for a monitored area comprising the steps of activating an alarm; detecting the presence of a person in the monitored area; and, de-activating the alarm in response to the detected presence of the person.

The method may include the additional steps of detecting the absence of the person in the monitored area; and, re-activating the alarm in response to the detected absence of the person.

The alarm may be de-activated temporarily for a period of time. The period of time may be user-defined.

The detecting of the presence of the person may be one of sensing a motion of the person and an input from the person.

The method may involve the additional steps of monitoring for at least one of an additional motion of the person and an additional input from the person; detecting the respective at least one of additional motion and additional input; and, resetting the deactivation period of time and counting down the reset deactivation period of time for each respective at least one of additional motion and additional input detected.

The present invention also provides a deterrent alarm system for a monitored area comprising an alarm; an alarm controller in communication with the alarm for activating and de-activating the alarm; and, a detector in communication with the alarm controller for detecting a person in the monitored area and communicating to the controller one of an indication that the person is detected and an indication that no person is detected, the controller de-activating the alarm in response to the indication that the erson is detected and activating the alarm in response to the indication that no person is detected.

The detector may be one of a motion sensor and an input device, such as a computer readable medium, a keypad, a microphone, and a door sensor.

The system may further comprise a deactivation timer in communication with the alarm controller for setting and counting down the deactivation period of time and communicating the expiry of the deactivation period of time to the controller.

### LIST OF FIGURES

Preferred embodiments of the present invention are described below with reference to the accompanying drawings in which:

FIG. 1 is a flowchart diagram illustrating the steps in a method according to an embodiment of the present invention;

FIG. 2 is a flowchart diagram illustrating additional steps in the method of FIG. 1;

FIG. 3 is a flowchart diagram illustrating the steps of step 1200 of the method of FIG. 1 according to an embodiment of the present invention;

FIG. 4 is a flowchart diagram illustrating the steps of step 1400 of the method of FIG. 1 according to an embodiment of the present invention;

FIG. 5 is a flowchart diagram illustrating the steps in a method according to an alternate embodiment of the present invention;

FIG. 6 is a flowchart diagram illustrating the steps in a method according to a further alternate embodiment of the present invention;

FIG. 7 is a flowchart diagram illustrating the additional steps in the method of FIG. 6;

FIG. 8 is a schematic view illustrating a system according to an embodiment of the present invention;

FIG. 9 is a schematic view of a component of the system of FIG. 8;

FIG. 10 is a schematic view illustrating a system according to an alternate embodiment of the present invention;

FIG. 11 is a schematic view illustrating a system according to a further alternate embodiment of the present invention; and,

FIG. 12 is a schematic view, illustrating a system according to a still further alternate embodiment of the present invention.

### DETAILED DESCRIPTION OF THE INVENTION

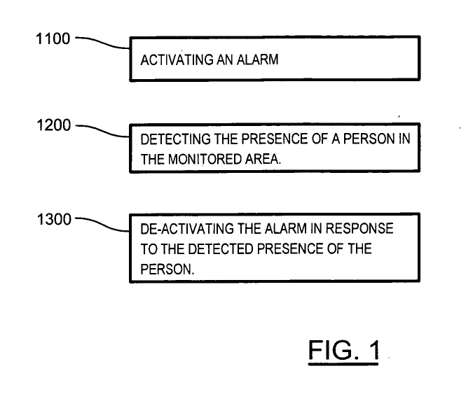

Referring to FIG. 1, a flowchart illustrates the steps in a method for controlling a deterrent alarm system for a monitored area according to an embodiment of the present invention. A step 1100, an alarm is activated. The alarm may be one or a combination of an auditory (i.e., sound) or visual alarm. At step 1200, the presence of a person in the monitored area is detected. The activated alarm is de-activated in response to the detected presence of the person in the monitored area (step 1300).

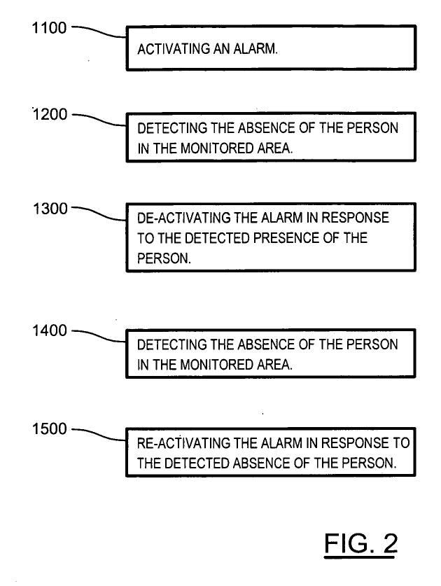

Referring to FIG. 2, a flow chart illustrates additional steps in the method of FIG. 1. At step 1400, there is no activity or person detected in the monitored area; an absence is detected; e.g., the person that was detected previously has left the monitored area. The de-activated alarm is re-activated in response to the absence of the person in the monitored area (step 1500).

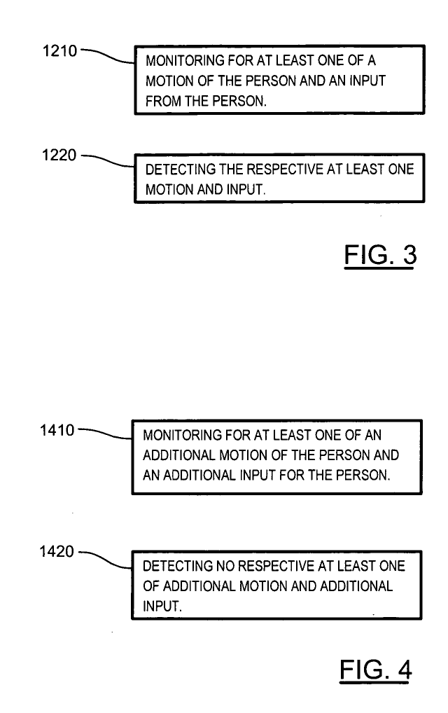

Referring to FIG. 3, a flowchart illustrates the additional steps of step 1200 in the method of FIG. 1. At step 1210, at least one of a motion of the person in the monitored area or an input from the person is monitored for. The respective at least one of the motion and the input is detected, thereby indicating the presence of the person in the monitored area (step 1220).

Referring to FIG. 4, a flowchart illustrates the additional steps of step 1400 in the method of FIG. 2. At step 1410, at least one of an additional motion of the person in the monitored area and an additional input for the person is monitored for. The respective at least one of the additional motion and additional input is not detected, thereby indicating the absence of the person in the monitored area (step 1420).

Referring to FIGS. 3 and 4, the input from the person in the monitored area may be inserting a computer readable medium into a medium reader. The computer readable medium may be a smart card™, a card having a magnetic strip or optical pattern. It will be apparent to those skilled in the art that any computer readable medium that can be read by a corresponding medium reader may be employed.

In an alternate embodiment, the input may include opening a door to the monitored area. For example, the door may be equipped with a door sensor, which senses that the door to the monitored area has been opened, thereby indicating the presence of the person in the monitored area. It will be apparent to those skilled in the art that any door sensor that is capable of sensing that a door with which it is associated may be employed.

In a further alternate embodiment, the input may include entering a keystroke on a keypad located in or at an entrance to the monitored area. It will be apparent to those skilled in the art that any known keypad may be employed.

In a still further embodiment, the input may include a sound generated by the person in the monitored area that is detected by a sound detector, such as a microphone. It will be apparent to those skilled in the art that any known sound detector may be employed.

Referring to FIG. 1, at step 1300 the alarm is deactivated temporarily. In a preferred embodiment, the alarm is de-activated for a period of time, which may be user defined.

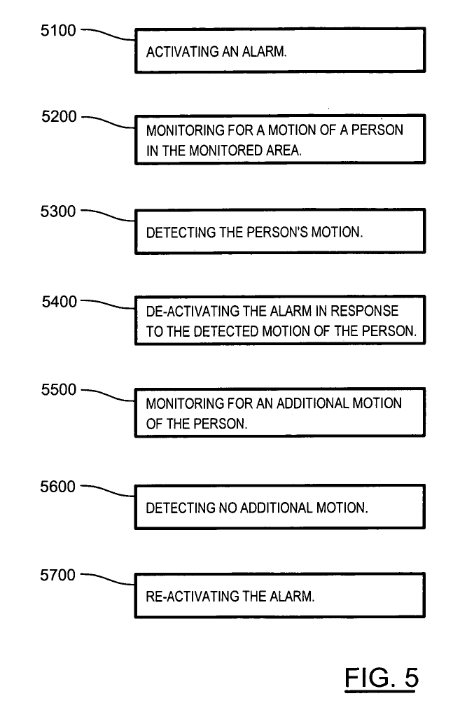

Referring to FIG. 5, a flowchart illustrates the steps in a method for controlling a deterrent alarm system for a monitored area according to an alternate embodiment of the present invention. At step 5100 an alarm in the monitored area is activated. A motion from a person in the monitored area is monitored for at step 5200. The person's motion is then detected (step 5300). In response to the detected motion of the person in the monitored area, the alarm is de-activated (step 5400). An additional motion of the person is monitored for at step 5500. When no additional motion is detected (step 5600), the alarm is re-activated (step 5700).

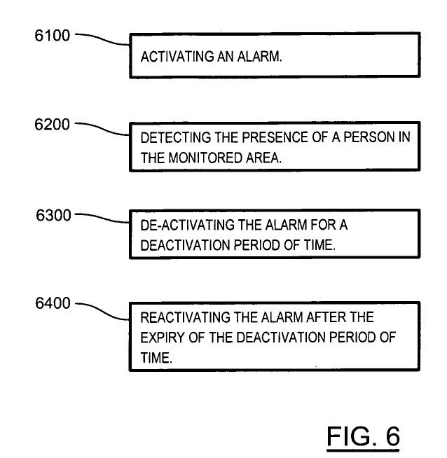

Referring to FIG. 6, a flowchart illustrates the steps in a method for controlling a deterrent alarm system for a monitored area according to a further alternate embodiment of the present invention. At step 6100, an alarm in the monitored area is activated. The presence of a person in the monitored area is detected at step 6200. In response to the detected presence, the activated alarm is deactivated for a deactivation period of time (step 6300). At step, 6400, after the expiration of the deactivation period of time, the deactivated alarm is reactivated.

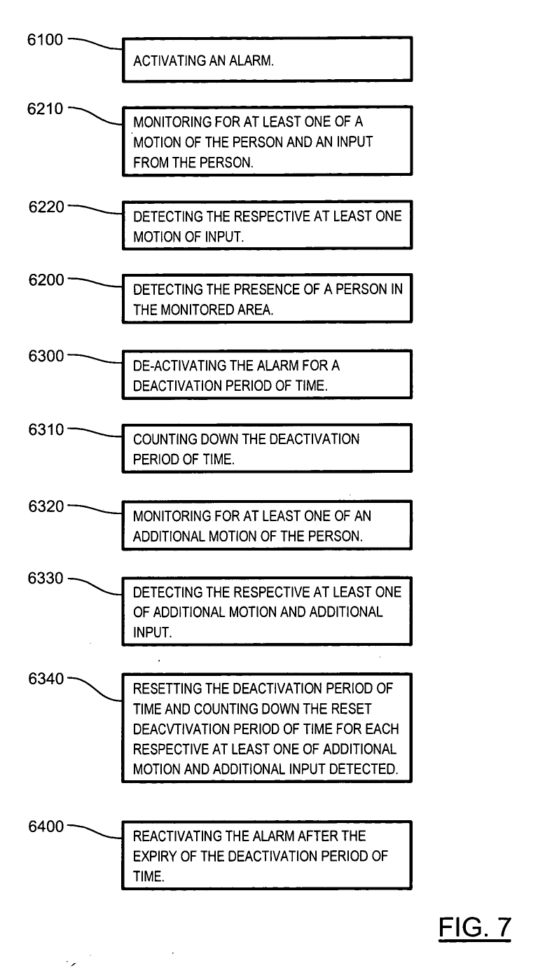

Referring to FIG. 7, a flowchart illustrates the additional steps of step 6200 in the method of FIG. 6. At step 6210, at least one of a motion of the person in the monitored area and an input from the person is monitored for. The respective at least one motion and input is detected at step 6220.

Step 6300 of FIG. 6 comprises the additional step (6310) of counting down the deactivation period of time (FIG. 7.).

Referring to FIG. 7, a flowchart illustrates the further additional steps of step 6300 in the method of FIG. 6. At step 6320, at least one of an addition motion of the person and an additional input from the person is monitored for. The respective at least one of additional motion and additional input is detected at step 6330. For each respective at least one of additional motion and additional input detected, the deactivation period is reset and the reset deactivation period is counted down (step 6340).

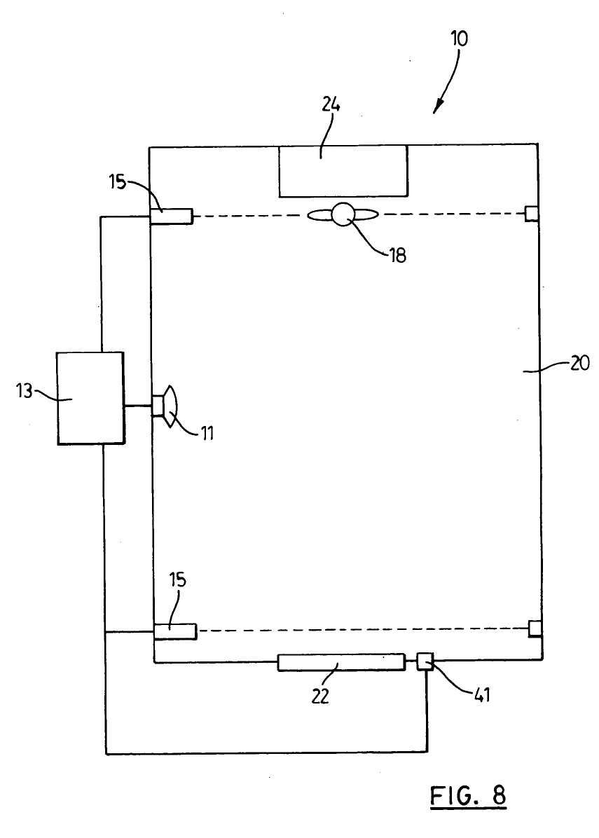

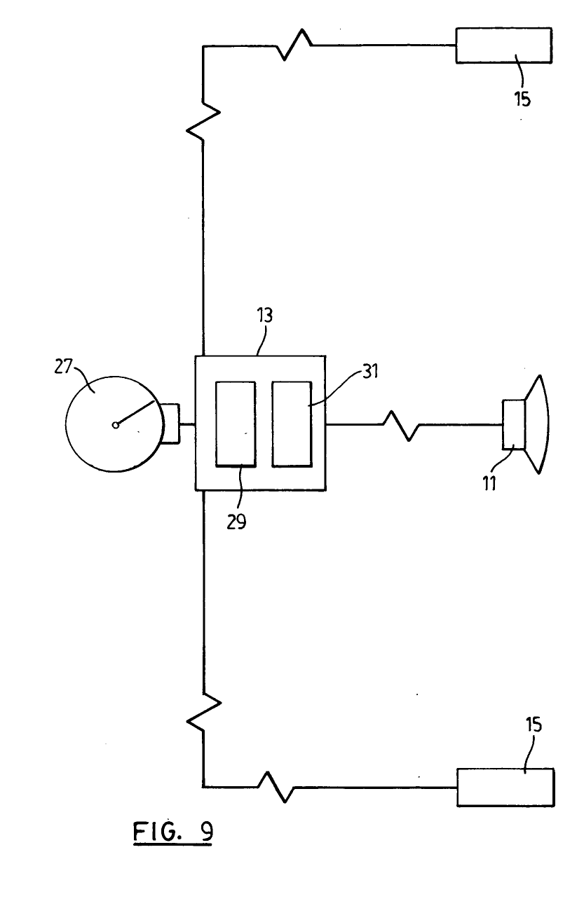

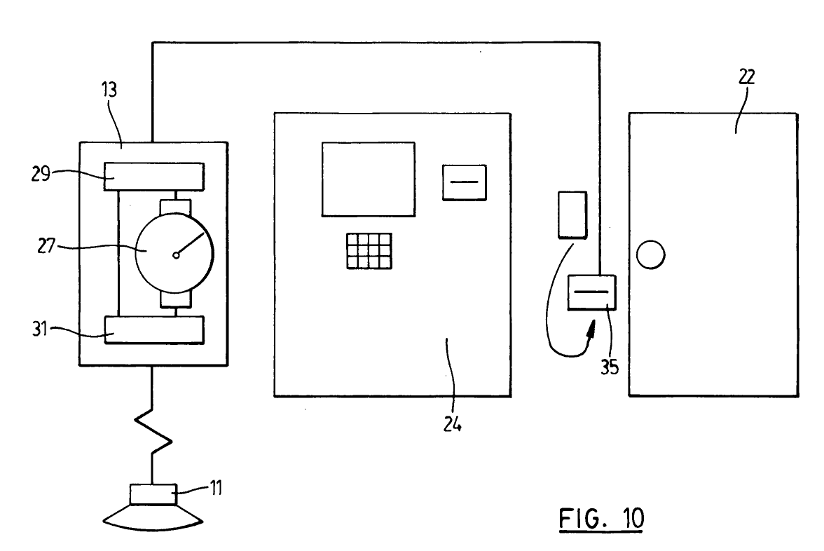

Referring to FIGS. 8 and 9, a deterrent alarm system 10 for a monitored area 20 is illustrated schematically according to an embodiment of the present invention. The system 10 comprises an alarm 11; an alarm controller 13 which is in communication with the alarm 11; and a detector 15 which is in communication with the alarm controller 13.

The detector 15 is configured to detect a person 18 in the monitored area 20. If the detector 15 detects a person 18 in the area 20, it communicates to the controller 13 an indication that a person is detected. The controller 13 is configured to deactivate the alarm 11 in response to the communicated indication. If the detector 15 detects that no person 18 is in the area 20, or does not detect a person 18 in the area 20, it communicates to the controller 13 an indication that no person 18 is detected. The controller 13, in response to the communicated indication that no person 18 was detected, either de-activates the alarm 11 if it has been deactivated previously, or does not deactivate the alarm 11 if it is activated presently.

The monitored area may be an ATM vestibule, a lobby entrance way, a secluded passageway (such as an underground walkway), or any area that receives low pedestrian traffic at certain times of the day. A user of the system 10 may activate the system at a set time of the day (e.g., dusk of early evening).

The detector 15 is a motion detector (or sensor), which is configured to detect a motion of a person within the monitored area. In a preferred embodiment, the motion detector is a narrow band motion detector. For example, the motion detector may be the Can Trex-IT as manufactured by Kantech of Toronto, Canada. It will, however, be apparent to those skilled in the art that any known motion detector that is able to detect a motion of a person and communicate this detection to the alarm controller 13 may be employed.

In an alternate embodiment of the present invention, the detector 15 is an input device. The input device may be a reader into which a computer readable medium is inserted and read. For example, the reader may be a magnetic card reader into which a magnetic card, such as an ATM card, is inserted. It will be apparent to those skilled in the art that any computer readable medium and corresponding reader may be employed, such as a smart card and an RFID.

In an alternate embodiment, the input device may be a keypad into which a person enters a keystroke. The keypad may be a button on a tenant directory in a lobby entrance way.

In a further alternate embodiment, the input device is a microphone or sound detector, which detects a sound generated by a person in the monitored area 20. The input device might also be a biometric interface or reader, such as a retinal scanner or a thumb or fingerprint reader.

In a still further alternate embodiment, the input device is a door sensor connected to a door to the monitored area 20. The door sensor senses that the door to the monitored area 20 has been opened and communicates an indirection that the door has been opened, and as such a person has been detected, to the alarm controller 13, which in response deactivates the alarm.

The controller 13 deactivates the alarm 11 temporarily for a deactivation period of time, which in a preferred embodiment is user-defined.

Referring to FIG. 9, the system 10 further comprises a deactivation timer 27, which is in communication with the alarm controller 13 via a timer controller 29. The timer controller 29 is used to set the deactivation period of time, count down the deactivation period of time and communicate the expiry of the deactivation period of time to the controller 13.

Referring to FIG. 9, the monitored area 20 is an ATM vestibule, such as those found in many commercial and bank buildings. During business hours this area experiences a fair amount of pedestrian traffic. However, during the evening and early morning hours, the traffic flow decreases significantly and the area may not be continuously monitored or watched. During those times of the day when there is low traffic in an area such as an ATM vestibule, the system 10 may be activated. The system 10 may be activated manually, or it may be scheduled to activate automatically at a particular time. For example, the system may be activated during the evening.

When the system 10 is activated, the alarm 11 is activated as a result. The alarm 11 may be one of auditory or visual (such as flashing lights, or a light of a different colour or intensity). Alternately, the alarm may be both auditory and visual. Once activated, the alarm 11 remains activated until system 10 is deactivated by a system user, or deactivated in response to the detected presence of a person 18 in the monitored area 20.

In a preferred embodiment, as the person 18 enters the monitored area 20, he or she opens the door 22. A door sensor 41 may be associated with the door 22, such that when the person 18 opens the door 22, the door sensor 41 senses that the door 22 has opened; i.e., the door sensor 41, acting as an input device, receives an input (the door opening) indicating the presence of a person 18 in the area 20. The door sensor 41 then communicates the received input (i.e., the door opening) to the alarm controller 13, which in response to the received communication deactivates the alarm 11. It will be apparent to those skilled in the art that any door sensor capable of sensing that a door has been opened, and communicating the door opened condition may be employed.

Referring to FIGS. 8 and 10, in an alternate embodiment, the door 22 is equipped with any detection device that communicates with the alarm controller 13 reader, into which a person inserts a card (e.g., an ATM card, a security pass card). On receiving the input, in the form of the inserted card, the card reader 35 communicates to the alarm controller 13 an indication that a person 18 has been detected and in response, the controller 13 deactivates the alarm 11. It will be apparent to those skilled in the art that any known door detection device that is able to detect that the door 22 to the monitored area 20 has been accessed or opened, and communicate this detection to the alarm controller 13 may be employed.

Referring to FIG. 8, in a preferred embodiment, a detector 15 is positioned at or near the doorway of the monitored area 20 (e.g., just inside the area 20), such that as the person 18 enters the monitored area 20, the detector 15 detects the presence of the person 18 and communicates this detected presence to the alarm controller 13, which deactivates the alarm 11. The detector 15 in a preferred embodiment is a motion sensor or detector. As the person 18 enters the area 20, he or she passes through the detection range of the motion detector. The motion detector is preferably positioned between waist height and shoulder height of the average person height, thereby reducing the likelihood that a person 18 simply sitting or lying in front of the detector 15 can deactivate the alarm 11. Alternately, the detector 15 may be positioned above the person 18 and facing the floor of the area 20. For example, the detector 15 may be positioned directly above the area in which the person 18 stands while operating the ATM 24.

In a preferred embodiment, a second detector 15 motion detector is positioned in the area 20 at or near the ATM 24, such that as the person 18 operates the ATM 24, the detector 15 detects the person 18 and communicates the detection to the alarm controller 13, which in turn deactivates the alarm 11. This second detector 15 is also preferably positioned at a height between waist and shoulder height of an average person.

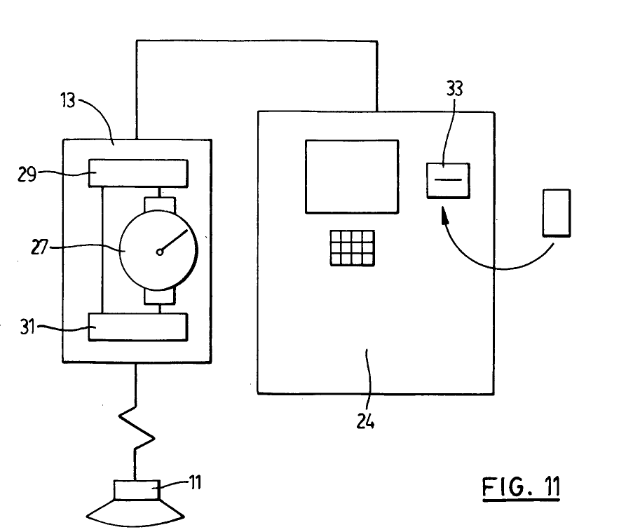

Referring to FIG. 11, in an alternate embodiment, the ATM card reader 33 may function as an input device 15. The person 18 approaches the ATM 24 and inserts his or her ATM card into the ATM card reader 33. The reader 33 communicates to the alarm controller 13 an indication that a person 18 has been detected in the area 20. The reader 33 continues to communicate this indication for as long as the ATM card is inserted in the reader 33. The alarm controller 13 on receiving the communicated indication deactivates the alarm 11

As the person 18 leaves the area 20, he or she passes through the detection range of the first motion detector, which is again communicated to the alarm controller 13 and the alarm is deactivated once again.

In a preferred embodiment, the alarm 11 is deactivated temporarily for a deactivation period of time, which may be pre-defined or defined by the system 10 user. To this card, the alarm controller 13 further includes a timer 27, which is in communication with a timer controller 29 and an alarm switch 31, which activates and deactivates the alarm 11. In an alternate embodiment, the timer 27 and timer controller 29 do not form a part of the alarm controller 13, but rather form a separate component that interacts and communicates with the alarm controller 13.

In a preferred embodiment, a deactivation period of time is selected by the system user. The timer 27 is then set to the selected deactivation period of time. When the detector 15 detects the presence of the person 18 in the area 20, it communicates the indication of detection to the alarm controller 13, which includes the alarm switch 31 and the timer controller 29. The switch 31 deactivates the alarm 11 in response to the communicated indication from the detector 15. The timer controller 29, also in response to the communicated indication from the detector 15, activates the timer 27, which then begins to count down the deactivation period of time. At the expiration of the deactivation period of time, the timer 27 communicates the expiration to the switch 31, which in response to the communicated expiration activates the alarm 11.

If, during the deactivation period of time, the detector 15 detects an additional motion and/or input from the person 18 in the area 20, it communicates this additional indication to the alarm controller 13 and timer controller 29. The timer controller 29, in response to this additional communicated indication, resets the timer 27 to the deactivation period of time and the timer 27 starts counting down the reset deactivation period of time. In a preferred embodiment, as long as the detector 15 continues to communicate additional indications to the alarm controller 13 that the person 18 is present in the area 20, the timer controller 29 resets the timer 27 and as a result the alarm 11 remains deactivated. When the person 18 exits the area 20, the detector 15 will no longer detect the person 18 in the area 20. The timer 27 then continues to count down the deactivation period of time. When the time expires, the timer 27 communicates the expiry of the deactivation period of time to the alarm switch 31 which in response activates the alarm 11.

Alternately, when the person 18 enters the area 20 and once in the area 20 remains still, out of view or no longer generates a detectable input, the detector 15 no longer detects an additional motion and/or input. Since no additional motion and/or input is detected, the timer continues to count down the deactivation period of time. When the time expires, the timer 27 communicates the expiry of the deactivation period of time to the alarm switch 31, which in response activates the alarm 11.

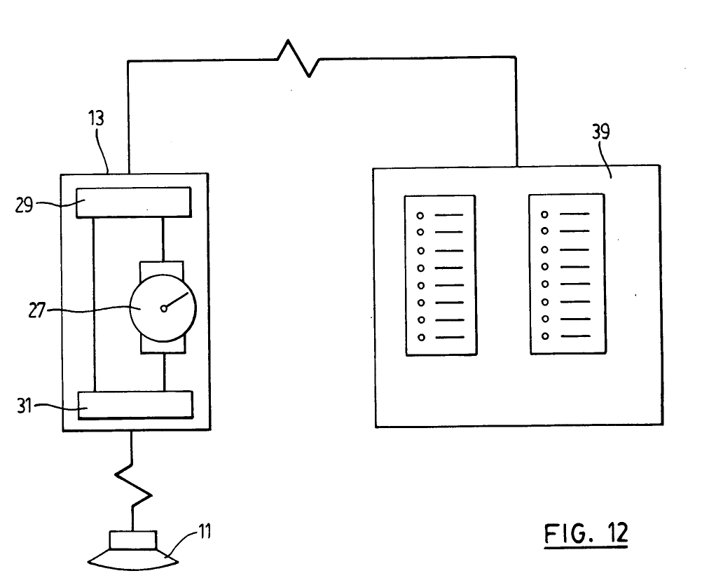

Referring to FIGS. 8 and 12, the monitored area 20 is a lobby entrance vestibule for a commercial or residential building. The entrance way includes a tenant directory and a directory input device 39, such as a button associated with a given tenant or a keypad for calling the tenant.

In a preferred embodiment, as the person 18 enters the entrance way, he or she opens the door. The door sensor 41 is associated with the door 22 and communicates to the alarm controller 13 an indication that the door has been opened (and as such the person 18 has been detected). The alarm controller 13 then deactivates the alarm 11. The lobby entrance way may also be equipped with motion detectors, which would detect the person's presence.

The person 18 then approaches the tenant directory and interacts with the directory input device 39 by either pressing a button associated with the tenant of interest, or entering a series of keypad strokes that allows the person to communicate with the tenant. On the person 18 interacting with the directory device 39, the device 39 communicates to the alarm controller 13 (with which it is in communication) an indication that a person has been detected. The alarm controller 13, in response, deactivates the alarm 11.

The above description is intended in an illustrative rather than a restrictive sense. Variations may be apparent to those skilled in the art without departing from the spirit and scope of the invention as defined by the claims set out below.

1. A method for controlling a deterrent alarm system for a monitored area comprising the steps of:
a. activating an alarm;
b. detecting the presence of a person in the monitored area; and,
c. de-activating the alarm in response to the detected presence of the person.

2. A method for controlling a deterrent alarm system for a monitored area according to claim 1, comprising the additional steps of:
d. detecting the absence of the person in the monitored area; and,
e. re-activating the alarm in response to the detected absence of the person.

3. A method for controlling a deterrent alarm system for a monitored area according to claims 1 and 2, wherein step (b) comprises the steps of:
i. monitoring for at least one of a motion of the person and an input from the person; and,
ii. detecting the respective at least one motion and input.

4. A method for controlling a deterrent alarm system for a monitored area according to claim 3, wherein step (d) comprises the steps of:
i. monitoring for at least one of an additional motion of the person and an additional input from the person; and,
ii. detecting no respective at least one of additional motion and additional input.

5. A method for controlling a deterrent alarm system for a monitored area according to claim 4, wherein the input includes inserting a computer readable medium into a medium reader in the monitored area.

6. A method for controlling a deterrent alarm system for a monitored area according to claim 4, wherein the input includes opening a door to the monitored area.

7. A method for controlling a deterrent alarm system for a monitored area according to claim 4, wherein the input includes entering a keystroke on a keypad in the monitored area.

8. A method for controlling a deterrent alarm system for a monitored area according to claim 4, wherein the input includes generating a sound in the monitored area.

9. A method for controlling a deterrent alarm system for a monitored area according to claim 1, wherein the alarm is de-activated temporarily.

10. A method for controlling a deterrent alarm system for a monitored area according to claim 9, wherein the alarm is de-activated for a period of time.

11. A method for controlling a deterrent alarm system for a monitored area according to claim 10, wherein the period of time is user-defined.

12. A method for controlling a deterrent alarm system for a monitored area according to claim 1, wherein the alarm is at least one of an auditory and visual alarm.

13. A method for controlling a deterrent alarm system for a monitored area comprising the steps of:
a. activating an alarm;
b. monitoring for a motion of a person in the monitored area;
c. detecting the person's motion;
d. de-activating the alarm in response to the detected motion of the person;
e. monitoring for an additional motion of the person;
f. detecting no additional motion; and,
g. re-activating the alarm.

14. A method for controlling a deterrent alarm system for a monitored area comprising the steps of:
a. activating an alarm;
b. detecting the presence of a person in the monitored area;
c. deactivating the alarm for a deactivation period of time; and,
d. reactivating the alarm after the expiry of the deactivation period of time.

15. A method for controlling a deterrent alarm system for a monitored area according to claim 14, wherein step b. comprises the additional steps of:
i. monitoring for at least one of a motion of the person and an input from the person; and,
ii. detecting the respective at least one motion and input.

16. A method for controlling a deterrent alarm system for a monitored area according to claim 14 and 15, wherein step c. comprises the additional step of counting down the deactivation period of time.

17. A method for controlling a deterrent alarm system for a monitored area according to claim 16, wherein step c. further comprises the additional steps of:
i. monitoring for at least one of an additional motion of the person and an additional input from the person;
ii. detecting the respective at least one of additional motion and additional input; and,
iii. resetting the deactivation period of time and counting down the reset deactivation period of time for each respective at least one of additional motion and additional input detected.

18. A method for controlling a deterrent alarm system for a monitored area according to claim 17, wherein the input includes one of the group consisting of inserting a computer readable medium into a medium reader, opening a door to the monitored area, and, entering a keystroke on a keypad.

19. A method for controlling a deterrent alarm system for a monitored area according to claim 18, wherein the alarm is at least one of an auditory and visual alarm.

20. A deterrent alarm system for a monitored area comprising:
an alarm;
an alarm controller in communication with the alarm for activating and de-activating the alarm; and,
a detector in communication with the alarm controller for detecting a person in the monitored area and communicating to the controller an indication that a person is detected, the controller being configured to deactivate the alarm in response to the indication that a person is detected.

21. A deterrent alarm system for a monitored area according to claim 20, wherein the detector further communicates to the controller an indication that no person is detected and the controller in response to the communicated indication activates the alarm.

22. A deterrent alarm system for a monitored area according to claim 21, wherein the detector is a motion sensor.

23. A deterrent alarm system for a monitored area according to claim 21, wherein the motion sensor is a narrow band motion sensor.

24. A deterrent alarm system for a monitored area according to claim 22, wherein the detector is an input device.

25. A deterrent alarm system for a monitored area according to claim 24, wherein the input device is a medium reader into which a computer readable medium is inserted.

26. A deterrent alarm system for a monitored area according to claim 24, wherein the input device is a keypad configured to receive a keystroke by the person in the monitored area.

27. A deterrent alarm system for a monitored area according to claim 24, wherein the input device is a microphone configured to detect a sound generated by the person in the monitored area.

28. A deterrent alarm system for a monitored area according to claim 24, wherein the input device is a door sensor connected to a door to the monitored area for sensing that the door has been opened.

29. A deterrent alarm system for a monitored area according to claim 20, wherein the controller de-activates the alarm temporarily.

30. A deterrent alarm system for a monitored area according to claim 29, wherein the alarm is deactivated for a period of time.

31. A deterrent alarm system for a monitored area according to claim 30, wherein the deactivation period of time is user-defined.

32. A deterrent alarm system for a monitored area according to claims 30 and 31, wherein the system further comprises:
a deactivation timer in communication with the alarm controller configured for counting down the deactivation period of time and communicating the expiry of the deactivation period of time to the alarm controller; and,
a timer controller in communication with the deactivation timer configured for setting the deactivation period of time, the timer controller also being in communication with the motion detector and further configured for receiving an indication that the person is present and starting the deactivation timer in response to the received indication.

33. A deterrent alarm system for a monitored area according to claim 32, wherein the detector is configured for communicating an additional indication that the person is present in the monitored area.

34. A deterrent alarm system for a monitored area according to claim 33, wherein the timer controller is further configured for receiving an additional indication that the person is present in the monitored area, resetting the deactivation period of time, and starting the timer to count down the reset deactivation period of time.

35. A deterrent alarm system for detecting the presence of a person in a monitored area comprising:
an alarm;
an alarm controller in communication with the alarm for activating and deactivating the alarm; and,
a motion detector in communication with the alarm controller for detecting a motion of the person in the monitored area and communicating the detected motion to the alarm controller, the alarm controller deactivating the alarm in response to the communicated detection.

36. A deterrent alarm system for a monitored area according to claim 35, wherein the alarm is deactivated for a period of time.

37. A deterrent alarm system for a monitored area according to claim 36, wherein the system further comprises:
a deactivation timer in communication with the alarm controller for counting down the deactivation period of time and communicating the expiry of the deactivation period of time to the alarm controller; and,
a timer controller in communication with the deactivation timer for setting the deactivation period of time, the timer controller also in communication with the motion detector for receiving an indication that the person is present, the timer controller starting the deactivation timer in response to the received indication.

38. A deterrent alarm system for a monitored area according to claim 37, wherein the motion detector configured for communicating an additional indication that the person is present in the monitored area.

39. A deterrent alarm system for a monitored area according to claim 38, wherein the timer controller is configured for receiving an additional indication that the person is present in the monitored area, resetting the deactivation period of time, and starting the timer to count down the reset deactivation period of time.
